(19) United States
(12) Patent Application Publication
(10) Pub. No.: US 2005/0039128 A1
(43) Pub. Date: Feb. 17, 2005

(54) AUDIO PLAYER WITH LYRICS DISPLAY

(76) Inventors: Ying-Hao Hsu, Chi-Lung City (TW); Su-Chuan Chao, Taipei City (TW)

Correspondence Address: (NAIPC) NORTH AMERICA INTERNATIONAL PATENT OFFICE, P.O. BOX 506, MERRIFIELD, VA, 22116, US

(21) Appl. No.: 10/604,746

(22) Filed: Aug. 14, 2003

(51) Int. Cl. G09G 5/00; G06F 17/00

(52) U.S. Cl. 715/728; 715/500.1; 715/716; 715/727; 715/729

(57) ABSTRACT

An audio player includes a memory for storing an audio file and a text file, the text file containing texts of the corresponding audio file. The audio player contains a user interface for selecting the audio file, a controller for loading the audio file and the text file, and a decoder for converting the audio file into audio signals. The audio player also includes an audio output port for outputting the audio signals, a video output port for displaying texts stored in the text file on a display device electrically connected to the video output port, and a text calculating circuit for calculating a rate at which text is displayed on the display device according to a predetermined relationship between a duration of the audio file and a size of the text file.

### BACKGROUND OF INVENTION

1. Field of the Invention

The present invention relates to an audio player, and more specifically, to an audio player capable of displaying lyrics corresponding to a played audio file.

2. Description of the Prior Art

With the advent of digital music being readily available, users have a new source of musical content. Digital music content resides in relatively small digital files that can be stored on portable non-volatile memory devices. Due to the popularity of digital music, portable music players such as Moving Pictures Expert Group, Layer 3 (MP3) players, as well as other types of audio players can be found everywhere.

Please refer to FIG. 1 and FIG. 2. FIG. 1 is a diagram of a portable audio player 10 according to the prior art. FIG. 2 is a functional block diagram of the portable audio player 10 shown in FIG. 1. The portable audio player 10 contains a memory 16 such as a flash memory for storing digital audio files. Currently, audio files in the MP3 format are commonly used in the portable audio player 10 due to their small file sizes. The portable audio player 10 contains an external connector 14 such as a male USB connector for allowing the portable audio player 10 to connect to a host device such as a computer. The portable audio player 10 connects to the host device for transferring digital audio files from the computer to the portable audio player 10, and vice versa. A controller 20 is used for controlling operations of the portable audio player 10. The portable audio player 10 contains a decoder 18 for converting the digital audio files stored in the memory 16 into analog audio signals.

The portable audio player 10 contains a display 12 for indicating an operating state of the portable audio player 10 to a user. For instance, the title of the current song being played can be indicated on the display 12 along with information about the battery life of the portable audio player 10. An audio output port 24 allows the user to hear the audio file being played on the portable audio player 10. The audio output port 24 is typically an earphone jack, although a speaker can be used instead of or in addition to the earphone jack.

The portable audio player 10 is popular for its small size and its simple design with no moving parts. However, the prior art portable audio player 10 does not offer users a way to read the lyrics of songs or audio files being played by the portable audio player 10. For instance, many people occasionally have trouble understanding words in songs, and have no convenient way to verify song lyrics at the time that they are listening to the song. In addition, students learning a new language often enjoy listening to popular songs to help improve their language skills. Unfortunately, not being able to read song lyrics of the songs that they are listening to can prevent the student from completely understanding the song.

### SUMMARY OF INVENTION

It is therefore a primary objective of the claimed invention to provide an audio player capable of displaying lyrics that correspond to a played audio file in order to solve the above-mentioned problems.

According to the claimed invention, an audio player includes a memory for storing a first audio file and a first text file, the first text file containing lyrics of the corresponding first audio file. The audio player contains a user interface for selecting the first audio file, a controller for loading the first audio file and the first text file, and a decoder for converting the first audio file into audio signals. The audio player also includes an audio output port for outputting the audio signals, a video output port for displaying lyrics stored in the first text file on a display device electrically connected to the video output port, and a text calculating circuit for calculating a rate at which text is displayed on the display device according to a predetermined relationship between a duration of the first audio file and a size of the first text file.

It is an advantage of the claimed invention that the audio player displays the lyrics stored in the first text file while the first audio file is playing for allowing users to easily read lyrics while listening to audio files. In addition, the calculating circuit calculates an average rate at which the lyrics appear in the audio file to save users the trouble of having to constantly scroll through the lyrics.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG.1 is a diagram of a portable audio player according to the prior art.

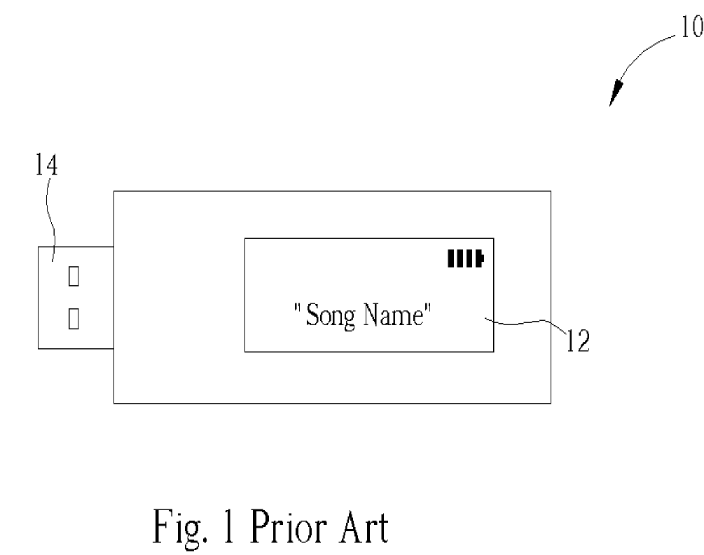

FIG. 2 is a functional block diagram of the portable audio player shown in FIG. 1.

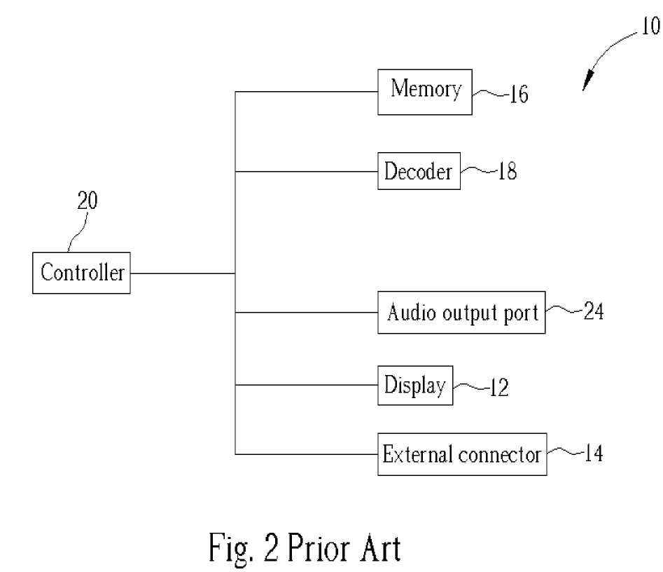

FIG. 3 is a block diagram of an audio player connected to a host device according to the present invention.

FIG. 4 shows how audio and text files are linked according to the present invention.

FIG. 5 is a flowchart illustrating using the audio player to play audio files and display lyrics stored in corresponding text files according to the present invention.

### DETAILED DESCRIPTION

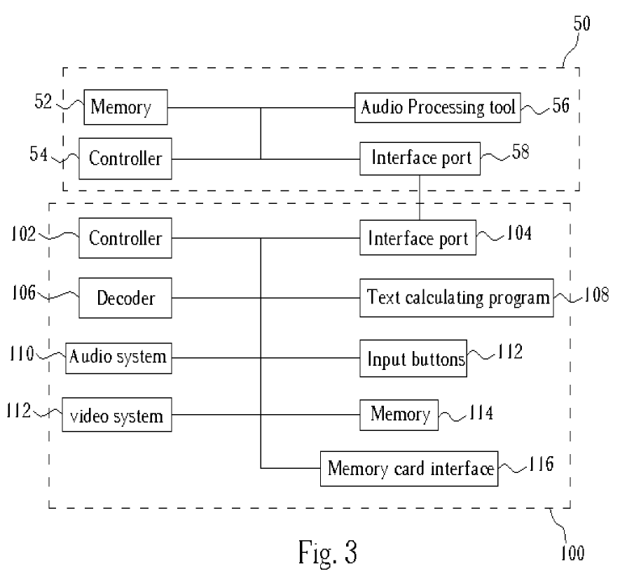

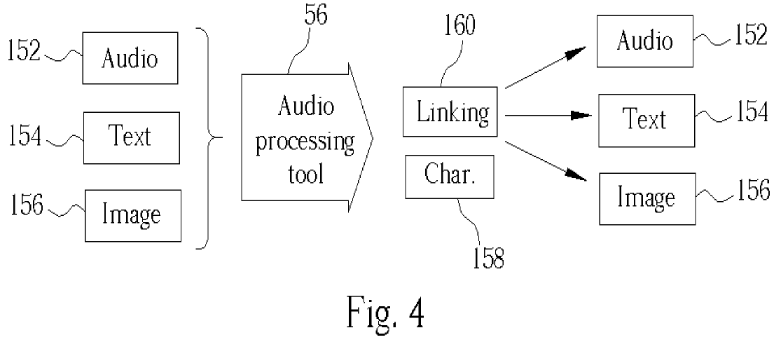

Please refer to FIG. 3 and FIG. 4. FIG. 3 is a block diagram of an audio player 100 connected to a host device 50 according to the present invention. It will be appreciated that the audio player 100 of the present invention may be incorporated into a personal digital assistant (PDA), digital still camera (DSC), mobile phone, or other electronic device capable of playing audio files. FIG. 4 shows how audio and text files are linked according to the present invention. The host device 50 uses an interface port 58 to transfer files to the audio player 100 through an interface port 104 of the audio player 100. The host device 50 may be a computer, and the interface ports 58 and 104 may use any type of data interface such as a parallel bus, serial bus, universal serial bus (USB), or IEEE 1394 serial bus. A controller 54 controls operations of the host device 50, and a memory 52 is used for storing files and data. The memory 52 of the host device 50 stores a plurality of audio files 152 to be played on the audio player 100. In addition, each of these audio files 152 has a corresponding text file 154 containing lyrics associated with the audio file 152 and a corresponding image file 156 containing a background image associated with the audio file 152. The host device 50 also includes an audio processing tool 56, which is a software program used for linking together corresponding audio files 152, text files 154, and image files 156, as will be explained in greater detail below. The audio files 152 can use any type of format including Moving Pictures Expert Group, Layer 3 (MP3), Windows Media Audio (WMA), WAV files, etc, so long as the file format is supported by the audio player 100. Likewise, a variety of file formats can be used for the text file 154 and the image file 156. For instance, the image file 156 may be stored in common image formats such as the JPEG or GIF formats.

The audio player 100 contains a controller 102 for controlling operations of the audio player 100. A decoder 106 is used for decoding the audio file 152 into audio signals. The decoder 106 can be an MP3 decoder, and is preferably capable of decoding more than one audio format. An audio system 110 receives the audio signals from the decoder 106 and outputs the audio signals through a connected earphone jack or speaker. A video system 112 is used to display the image file 156 and the lyrics stored in the text file 154 that corresponds to the audio file 152 being played by the audio player 100. To output the video signals, a display device such as a liquid crystal display (LCD) or a television can be connected to the video system 112. The audio player 100 contains a memory 114 for storing audio files 152, text files 154, and image files 156 transferred from the host device 50 through the interface port 104. In addition, the audio player 100 also contains a memory card interface 116 for reading files from a removable memory card such as a Compact Flash (CF), Secure Digital (SD), Smart Media (SM), or other such memory card. The use of the memory card interface 116 allows new files to be played through the audio player 100 without having to connect the audio player 100 to the host device 50. However, in this case, the removable memory card should contain audio files 152, text files 154, and image files 156 that have already been properly linked together.

As shown in FIG.4, the audio processing tool 56 locates corresponding audio files 152, text files 154, and image files 156 and generates a linking file 160 for each set of files. Each linking file 160 would point to one audio file 152, its corresponding text file 154 containing the lyrics of the audio file 152, and the corresponding image file 156 containing the background image associated with the audio file 152. When a user wishes to transfer audio files 152 from the host device 50 to the audio player 100, the user first chooses a selection of audio files 152 through the audio processing tool 56. The audio processing tool 56 will then generate the plurality of linking files 160 that link corresponding audio files 152, text files 154, and image files 156. Once this is done, the audio processing tool 56 knows exactly which characters of text have been used in the text files 154. The audio processing tool 56 generates a character set file 158, which is a minimized list of characters contained in all of the text files 154. For example, suppose that some of the audio files 152 are in the Chinese language while others are in the Russian language. Instead of storing the entire character set tables of both Chinese and Russian in the memory 114, the character set file 158 is created instead which only stores the characters actually used in the text files 154. Of course, the present invention is not limited to the use of the character set file 158, and any number of partial or complete character set tables can be stored in the memory 114 of the audio player 100.

When the audio player 100 starts playing one of the audio files 152, the text file 154 pointed to by the corresponding linking file 160 will also be loaded. The present invention offers a feature of automatically scrolling the lyrics contained in the text file 154 to save a user the trouble of constantly having to manually scroll through the lyrics. A text calculating program 108 of the audio player 100 automatically calculates a rate at which the lyrics of the text file 154 are scrolled across the display device connected to the video system 112. For calculating the rate at which the lyrics are displayed on the display device, the duration of the audio file 152 is measured and the size of the text file 154 is calculated. The rate is then found according to the equation F=T/N, where F represents a moving frequency at which the lyrics are displayed on the display device, T represents the duration of the audio file 152 and, N represents a quantity of text stored in the text file 154. The quantity of text N can be calculated using a variety of different units. For instance, a number of characters N_{C}, words N_{W}, sentences N_{S}, or paragraphs N_{P} contained in the text file 154 can be used to represent the quantity of text stored in the text file 154. The units used for calculating the quantity of text N can be specified by the user of the audio player 100 or can be preset by the manufacturer.

The automatic scrolling of the lyrics of the text file 154 assumes that the lyrical content of the corresponding audio file 152 is evenly distributed throughout the audio file 152. If this is the case, the user will not have to manually scroll through the lyrics while listening to the entire duration of the audio file 152. The audio player 100 will show one page of text on the display device for a period of time associated with the calculated rate. If the lyrical content of the corresponding audio file 152 is not evenly distributed throughout the audio file 152, the user can make use of input buttons 112 to manually scroll through the lyrics. The input buttons 112 preferably contain an Up button and a Down button, which are respectively used to scroll up and scroll down through the lyrics of the audio file 152 currently being played. Alternatively, the input buttons 112 can be used to increase or decrease the rate at which text is displayed, according to settings of the audio player 100.

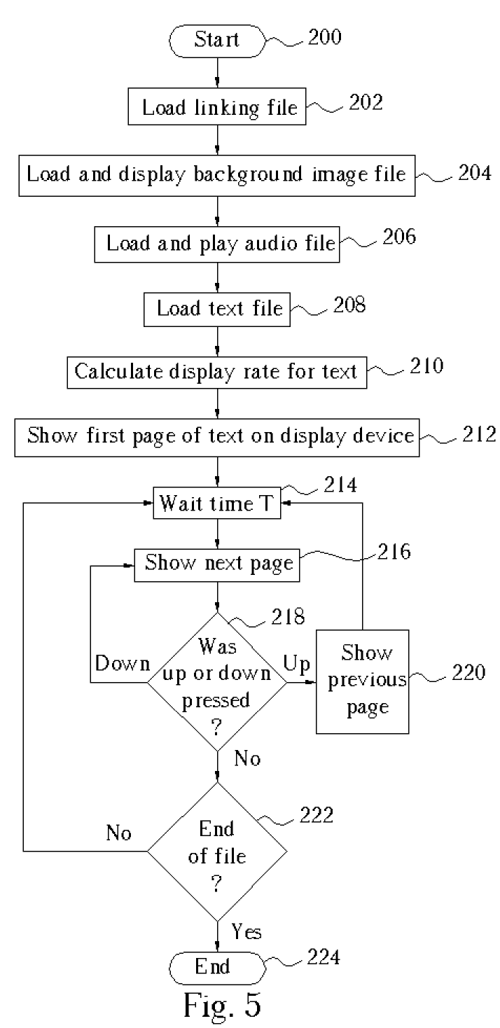

Please refer to FIG. 5. FIG. 5 is a flowchart illustrating using the audio player 100 to play audio files 152 and display lyrics stored in corresponding text files 154 according to the present invention. Steps contained in the flowchart will be explained below.
Step 200: Start;
Step 202: Load the linking file 160 corresponding to an audio file 152 selected for playing;

Step 204: Load the image file 156 pointed to by the linking file 160, and display the image file 156 as a background image on the display device connected to the video system 112;
Step 206: Load and begin playing the audio file 152 corresponding to the linking file 160;
Step 208: Load the text file 154 pointed to by the linking file 160;
Step 210: Calculate the rate at which the lyrics of the text file 154 are displayed on the display device according to the equation F=T/N;
Step 212: Show a first page of text on the display device;
Step 214: Wait for a period of time T that is inversely proportional to the rate at which text is displayed on the display device;
Step 216: Show a next page of text on the display device;
Step 218: Determine if one of the input buttons 112 was pressed. If the Up button was pressed, go to step 220. If the Down button was pressed, go back to step 216. If no input buttons 112 were pressed, go to step 222;
Step 220: Since the Up button was pressed, show a previous page of text on the display device; go to step 214;
Step 222: Determine if the end of the audio file 152 has been reached. If so, go to step 224. If not, go back to step 214; and
Step 224: End.

In contrast to the prior art audio player, the present invention audio player 100 displays lyrics corresponding to the audio file 152 being played by the audio player 100. The linking file 160 is used to link each audio file 152 to its corresponding text file 154 and image file 156. Moreover, users of the audio player 100 do not have to manually scroll through the lyrics stored in the text file 154 since the text calculating program 108 automatically calculates a text scrolling rate. Thus, the present invention audio player 100 offers an easy way to read the lyrics corresponding to an audio file 152 while simultaneously listening to the audio file 152.

Those skilled in the art will readily observe that numerous modifications and alterations of the device may be made while retaining the teachings of the invention. Accordingly, the above disclosure should be construed as limited only by the metes and bounds of the appended claims.

1. An audio player comprising:
a memory for storing a first audio file and a first text file,
the first text file containing texts of the corresponding first audio file;
a user interface for selecting the first audio file;
a controller for loading the first audio file and the first text file;
a decoder for converting the first audio file into audio signals;
an audio output port for outputting the audio signals;
a video output port for displaying texts stored in the first text file on a display device electrically coupled to the video output port; and
a text calculating circuit for calculating a rate at which text is displayed on the display device according to a predetermined relationship between a duration of the first audio file and a size of the first text file.

2. The audio player of claim 1 further comprising a first linking file stored in the memory, the first linking file utilized for linking the first text file to the corresponding first audio file.

3. The audio player of claim 1 further comprising a first image file stored in the memory for serving as a background image when text from the corresponding first text file is displayed on the display device.

4. The audio player of claim 1 wherein the predetermined relationship for calculating the rate at which text is displayed on the display device satisfies the equation F=T/N, where F represents a moving frequency at which text is displayed on the display device, T represents the duration of the first audio file and, N represents a quantity of text stored in the first text file.

5. The audio player of claim 4 wherein the user interface is utilized for selecting a calculation mode of the audio player.

6. The audio player of claim 5 wherein the quantity of text N is selected from a group consisting of N_{C}, N_{W}, N_{S}, and N_{P} according to the selected calculation mode, wherein N_{C} represents a number of characters in the first text file, N_{W} represents a number of words in the first text file, N_{S} represents a number of sentences in the first text file, and N_{P} represents a number of paragraphs in the first text file.

7. The audio player of claim 1 wherein the user interface comprises input buttons for scrolling through the text displayed on the display device.

8. The audio player of claim 1 wherein the user interface comprises input buttons for changing the rate at which text is displayed on the display device.

9. The audio player of claim 1 further comprising an interface port for transferring files from a host device to the memory of the audio player.

10. The audio player of claim 1 further comprising a character set file stored in the memory, the character set file containing a list of all characters included in all text files stored in the memory of the audio player.

11. The audio player of claim 1 wherein the decoder is an MP3 decoder.

12. A method of displaying text corresponding to an audio file on an audio player, the method comprising:
selecting a first audio file;
loading a first text file corresponding to the first audio file;
calculating a rate at which text is displayed on a display device electrically coupled to the audio player according to a predetermined relationship between a duration of the first audio file and a size of the first text file; and
displaying texts stored in the first text file on the display device at the calculated rate while simultaneously outputting audio signals decoded from the first audio file.

13. The method of claim 12 further comprising reading a first linking file and locating the first text file and the first audio file according to linking identifiers stored in the first linking file.

14. The method of claim 12 further comprising utilizing a first image file as a background image when text from the corresponding first text file is displayed on the display device.

15. The method of claim 12 wherein the predetermined relationship for calculating the rate at which text is displayed on the display device satisfies the equation F=T/N, where F represents a moving frequency at which text is displayed on the display device, T represents the duration of the first audio file and, N represents a quantity of text stored in the first text file.

16. The method of claim 15 further comprising selecting a calculation mode of the audio player, wherein the quantity of text N is selected from a group consisting of N_{C}, N_{W}, N_{S}, and N_{P} according to the selected calculation mode, wherein N_{C} represents a number of characters in the first text file, N_{W} represents a number of words in the first text file, N_{S} represents a number of sentences in the first text file, and N_{P} represents a number of paragraphs in the first text file.

17. The method of claim 12 further comprising providing input buttons for scrolling through the text displayed on the display device.

18. The method of claim 12 further comprising providing input buttons for changing the rate at which text is displayed on the display device.

19. The method of claim 12 further comprising transferring the first audio file and the first text file to the audio player from a host device.

20. The method of claim 12 further comprising providing a character set file, the character set file containing a list of all characters included in all text files stored in the audio player.

21. The method of claim 20 wherein providing the character set file further comprises assigning a unique numerical code to each character contained in the character set file.

22. The method of claim 21 wherein displaying texts stored in the first text file on the display device comprises reading a plurality of numerical codes from the first text file, reading the characters corresponding to the numerical codes from the character set file, and displaying the characters on the display device.
